(19) United States
(12) Patent Application Publication
(10) Pub. No.: US 2005/0142280 A1
(43) Pub. Date: Jun. 30, 2005

(54) System and method for synthesizing a polymer membrane

(76) Inventors: Kwon Il Kim, Burlington (CA); Mailvaganam Mahendran, Mississauga (CA); Hua Chen, Burlington (CA); Wayne Jerald Henshaw, Burlington (CA)

Correspondence Address: ANDREW ALEXANDER & ASSOCIATES, 3124 KIPP AVENUE, P.O. BOX 2038, LOWER BURRELL, PA, 15068, US

(21) Appl. No.: 10/969,798

(22) Filed: Oct. 20, 2004

Related U.S. Application Data
(60) Provisional application No. 60/512,081, filed on Oct. 20, 2003.
(60) Provisional application No. 60/527,718, filed on Dec. 9, 2003.

(51) Int. Cl. B05D 7/22; B05D 5/00

(52) U.S. Cl. 427/2.1; 427/230; 427/245

(57) ABSTRACT

A method of synthesizing a polymer membrane is described in which a polyvinylidene compound or an ethylene compound is blended with a solvent. The blend is applied on a supporting material, such as the outside of a hollow braid or the inside of a porous tube. Subsequently, the blend is cooled to thereby induce polymer membrane formation on the supporting material.

This is an application claiming the benefit under 35 USC 119(e) of U.S. Provisional Patent Application Ser. No. 60/512,081, filed Oct. 20, 2003 and U.S. Provisional Patent Application Ser. No. 60/527,718, filed Dec. 9, 2003. U.S. application Ser. Nos. 60/512,081 and 60/527,718 are incorporated herein, in their entirety, by this reference to them.

### FIELD OF THE INVENTION

This invention relates to microporous membranes, and more specifically to a method and system for synthesizing a polymer microporous membrane.

### BACKGROUND OF THE INVENTION

Microporous membranes are widespread and have myriad applications. For example, microporous membranes are used for microfiltration and ultrafiltration in the pharmaceutical, biomedical and food industries. Microporous membranes also find use in dialysis, membrane distillation, membrane solvent extraction, membrane gas absorption, stripping, water purification and water treatment.

Microporous membranes have been prepared by a variety of methods, including sintering of ceramic, graphite, metal or crystalline polymer powders; stretching of extruded homogeneous polyolefin or polytetrafluoroethylene films; track etching of homogeneous polycarbonate or polyester films; and phase inversion solution casting of a variety of polymers.

Induced phase separation in a polyvinylidene fluoride mixture may yield a microporous membrane. In particular, non-solvent induced phase separation (NIPS) and thermal induced phase separation (TIPS) are two processes for producing polyvinylidene fluoride microporous membranes. In the NIPS process, polyvinylidene fluoride is dissolved in a solvent, optionally with some non-solvent, with pore formers to make a homogeneous solution (blend). The porous structure is formed when the blend is quenched in a non-solvent (such as water).

In the TIPS process, the polymer is combined with a solvent and optional nonsolvent and nucleating agents. The mixture is subsequently heated to melt the blend and to form a homogeneous solution. When the solution is fast quenched or cooled, phase separation occurs in the blend system, leading to the formation of a porous structure.

### SUMMARY OF THE INVENTION

Notwithstanding the fact that both NIPS and TIPS can yield a membrane with desirable characteristics, these processes, as currently implemented, have some drawbacks. Conventional NIPS and TIPS processes yield membranes with tensile break strengths of about 1 to 15 N/mm2. These tensile strengths are too small for many applications. In addition, the use of mixed solvents in the production process makes it difficult to recover them for recycling or proper disposal. Also, many NIPS and TIPS processes yield a membrane that has a pore size greater than 0.1 microns, which is not suitable in many ultrafiltration applications.

The present invention addresses the aforementioned problems associated with the conventional production of microporous membranes. The methods provided herein use a solvent, such as a high boiling latent solvent, in a thermally induced phase separation process to produce a membrane with excellent characteristics. A braid supports the membrane. The result is a membrane having a high tensile strength, a finely porous surface and a long lifetime.

In particular, a method of synthesizing a polymer membrane is described herein. The method includes blending a polymer with a solvent, melting the resultant blend, and coating the outside of a braid or the inside of a porous tube with the blend. Cooling the blend induces formation of a polymer membrane that remains affixed to the braid for support. Alternatively, the inside of a porous tube can be coated with the resultant blend. The porous tube can be fabricated from a helical wrapping and overlaying layer of high strength, high porosity nonwoven fabric. Further details of such a tube can be found in U.S. Pat. No. 4,101,423, which is incorporated herein by reference.

The solvent can be a high boiling latent solvent, such as at least one of butyl benzyl phthalate, dibutyl phthalate, triacetin, glyceryl diacetin, triisononyl trimellitate, tri isodecyl trimellitate, tri-n-hexyl trimellitate, butyl phthalyl butyl glycolate and tri iso octyl trimellitate.

The polymer can include a polyvinylidene fluoride polymer. Alternatively, the polymer can include an ethylene polymer, such as the Halar™ copolymer, ethylene chlorotrifluoroethylene polymer, or the Halar™ terpolymer, ethylene chlorotrifluoroethylene butylacrylate polymer. Halar™ polymers are made by Solvay Solexis™.

### BRIEF DESCRIPTION OF THE DRAWINGS

For a better understanding of the present invention and to show more clearly how it may be carried into effect, reference will now be made, by way of example, to the accompanying drawing, in which:

FIG. 1 shows a flowchart for synthesizing a polymer membrane, according to the teachings of the present invention.

FIG. 2 shows a system for producing a braided semi-permeable hollow fiber membrane.

### DETAILED DESCRIPTION OF THE INVENTION

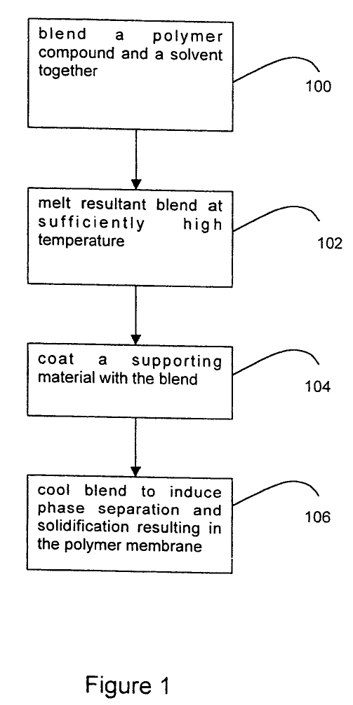

FIG. 1 shows a flowchart for synthesizing a polymer membrane. In step 100, a polymer and a solvent are blended together. Optionally, a nucleating agent, such as at least one of talc, silica, calcium carbonate and alumina, may be added. If silica is used, a large surface area (greater than 100 m²/g) is advantageous.

The polymer can include a polyvinylidene fluoride polymer. Alternatively, the polymer can include an ethylene polymer, such as the Halar™ polyethylene chlorotrifluoroethylene copolymer or polyethylene chlorotrifluoroethylene butylacrylate terpolymer.

In step 102, the resultant blend is melted by heating at sufficiently high temperatures. In step 104, a supporting material is coated with the blend. Subsequently, in step 106, the blend is cooled to thereby induce formation of a polymer membrane that remains affixed to the supporting material for support. In particular, the cooling causes phase separation and solidification resulting in a polymer membrane disposed on the supporting material.

This membrane is microporous and useful for liquid separation processes, or as a support for other membranes used for composite gas or liquid separation processes. In one embodiment, the polymer membrane has a bubble point that is at least 10 psi, and a water flux that is at least 10 gfd/psi at 25° C.

Polyvinylidene fluoride polymers are generally fluorine compounds having the chemical structure of —(CH₂—CF₂)ₙ— (where n is a positive integer) and having an average fluoride content of about 60 percent in one repeat unit.

As used herein, the term “polyvinylidene fluoride polymer” includes vinylidene fluoride homopolymers, and random and block copolymers of vinylidene fluoride. Examples of such copolymers include vinylidene fluoride-hexafluoropropylene copolymers, vinylidene fluoride-tetrafluoroethylene copolymers, vinylidene-ethylene copolymers, vinylidene fluoride-chlorotrifluoroethylene copolymers and vinylidene fluoride-perfluorovinylether copolymers. Terpolymers, physical blends of polymers of polyvinylidene fluoride polymers, as well as mixtures of the aforementioned compounds, also fall under the rubric of “polyvinylidene fluoride polymer.”

In one embodiment of the present invention, polymers with an ordered crystalline structure, in which methylene groups and methylene difluoride groups are bonded alternately, and/or polymers having an average molecular weight of about 150,000 or greater are preferably used.

Several solvents can be used in the step 100 of blending. One particular class of solvents that is appropriate includes high boiling latent solvents. As used herein, a high boiling solvent is a solvent that boils at about 250° C. or greater, and a latent solvent is a solvent into which a solute melts to yield a homogeneous solution at a temperature of about 100° C. or greater. A high boiling latent solvent is a solvent having both these characteristics. For example, in one embodiment, the high boiling latent solvent used, benzyl butyl phthalate, substantially dissolves the polyvinylidene fluoride compound at about 100° C. Other appropriate high boiling latent solvents include dibutyl phthalate, triacetin, glyceryl diacetin, triisononyl trimellitate, tri isodecyl trimellitate, tri-n-hexyl trimellitate and butyl phthalyl butyl glycolate.

When heated to above its melting point and with proper mixing, the aforementioned polymers are miscible with the high boiling latent solvent and form a homogeneous solution. Heating to above the polymer melting point reduces the mixing time. The used solvent can be recycled after the addition of an extraction solvent, minimizing waste discarded into the environment.

The concentrations of the components of the blend depend in turn on the desired concentrations during the extrusion, molding, or spinning process. Miscibility of the composition at the extrusion, molding or spinning temperature is one factor to be considered in shaping the blend. Miscibility of polymer solutions may be readily determined empirically by methods known in the art. The amount of the diluents used in the composition is advantageously sufficient to itself solubilize the polyvinylidene fluoride polymer at the extrusion, molding, or casting temperature; that is, no other solvent other than the high boiling latent solvent is necessary to solubilize the polyvinylidene fluoride polymer. The target pore size of the membrane, transport rate through the membrane, and membrane strength are dictated by the ultimate use of the membrane, and it is these factors that determine the appropriate blend composition.

For forming the membranes of this invention, the concentration of polyvinylidene fluoride polymer in the mixture is preferably at least about 10 weight percent, more preferably at least about 15 weight percent, even more preferably at least about 18 weight percent; the concentration of polyvinylidene fluoride polymer is preferably less than about 90 weight percent, more preferably less than about 75 weight percent, even more preferably less than about 60 weight percent. The concentration of the solvent is preferably at least about 20 weight percent, more preferably at least about 40 weight percent; the concentration of the solvent is preferably less than about 90 weight percent, more preferably less than about 85 weight percent. The concentration of the nucleating agent is preferably at least about 0.01 weight percent, and more preferably at least about 0.1 weight percent. The concentration of the nucleating agent is preferably less than about 20 weight percent, more preferably less than about 10 weight percent.

In the melting step 102, the polymer and the solvent may be heated and mixed in any convenient manner with conventional mixing equipment, such as a jacket-heated batch mixer. Alternatively, the mixture may be homogenized by extruding the mixture through a twin screw extruder, cooling the extrudate, and grinding or palletizing the extrudate to a particle size that is readily fed to a single or twin screw extruder. The components of the mixture may also be combined directly in a melt-pot or twin-screw extruder and extruded into membranes in a single step.

The mixture is heated to a temperature that results in a homogeneous mixture processing a viscosity suitable for extrusion, spinning or molding. The temperature should not be so high as to cause significant degradation of the polymer. On the other hand, the temperature should not be so low as to render the mixture too viscous to extrude. The blend temperature for extrusion, molding or spinning is preferably at least about 20° C., more preferably at least about 50° C.; the extrusion temperature is preferably less than about 250° C., more preferably less than about 230° C.

The step of coating 104 can proceed using a number of supporting materials and methods. For example, the polymer blend can be extruded around a hollow braid comprises of polyester, nylon or glass fiber. In one embodiment, the outer diameter of the tubular braid has an outer diameter of about 0.5 mm to 3 mm and an inner diameter of about 0.25 mm to 2.5 mm.

The blend is then quenched to yield the polymer membrane that forms an outer coating on the hollow braid. Unexpectedly, the membrane has very good adhesion to the braid. In particular, the polymer membrane remains affixed to the braid during the working life of the membrane, the braid providing support thereto. Thus, a supported hollow fiber results that has extraordinary tensile strength. Further details of the braid, including a method of manufacturing same, are provided in U.S. Pat. No. 6,354,444 B1, the contents of which are incorporated herein by reference.

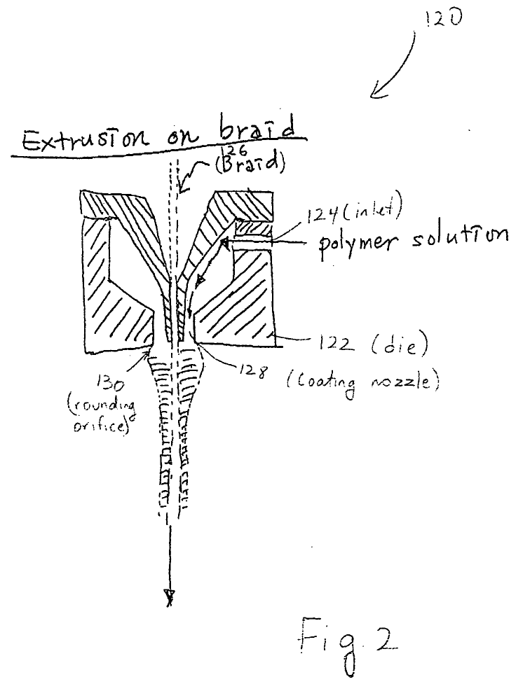

FIG. 2 shows a system 120 for producing a braided semi-permeable hollow fiber membrane. The system 120 includes a die 122 having an inlet 124 and a braid 126.

The polymer solution blend is introduced into the die 122 via the inlet 124. The blend is extruded through a coating nozzle 128 onto the braid 126. The blend is then cooled to induce membrane formation on the braid 126.

The polymer solution blend is introduced into the coating nozzle at a flow rate determined by the speed that the tubular braid 126 is advanced through a rounding orifice 130 of the coating nozzle 128. The flow rate should provide only as much blend as can be supported on the outer portion of the braid 126. The membrane may be coated on a tubular macroporous support made of synthetic fiber or glass fiber.

Details of two experimental methods for producing the membrane coated braid of FIG. 2 are now provided.

One experimental method produces a polyvinylidene fluoride polymer, hollow-fiber membrane on a braid by thermal induced phase separation. In particular, a solution of 24.5% (w/w) of polyvinylidene fluoride powder, manufactured and sold by Solvay Solexis™, 74.5% (w/w) of benzyl butyl phthalate, manufactured and sold by Ferro™, and 1% (w/w) hydrophobic silica, manufactured by Aerosil™, are mixed and heated in a reactor.

The resultant blend is degassed at 220° C. for 2 hours. Next, the blend is extruded at 220° C. on a-polyester-based hollow braid through a spinnerette having an annular, hollow-fiber spinning nozzle.

The extruded fiber on the braid is quenched in tap water at room temperature and solidified, forming a hollow fiber membrane. The extruded hollow fiber is immersed in isopropyl alcohol at 20° C. for 3 hours to extract the benzyl butyl phthalate therefrom. The fiber is then annealed at 120° C. for 5 min. The resultant fiber has a 1.9 mm outer diameter and the following characteristics:
pore size (from scanning electronic micrograph): 0.04 microns
burst pressure: >25 psi
water permeability: 11.5 gfd/psi

A second experimental method produces an ethylene polymer (viz., a Halar™ polymer) hollow-fiber membrane on a braid by thermal induced phase separation. Six examples involving such an ethylene polymer are now described.

### EXAMPLE 1

25% by weight of Halar™ terpolymer (XPM-2™ produced by Solvay Solexis) and 75% by weight of a tri-isononyl trimellitate (Jayflex™, produced by Exxon Mobil™ Chemical) are mixed in a reactor and heated up to 230° C.

By means of a hollow fiber apparatus such as shown in FIG. 2, the mixture obtained is extruded into a hollow fiber on the braid made of polyester synthetic fiber. The hollow fiber is quenched in water and is immersed in pure isopropyl alcohol at room temperature for 10 hours to extract the tri-isononyl trimellitate latent solvent. Next, the hollow fiber is washed in water for 1 hour. The porous membranes thus obtained have a three dimensional porous structure. Physical characteristics of the resultant membrane are listed in Table 1.

### EXAMPLES 2 TO 5

A porous membrane of a Halar™ terpolymer is obtained in the same way as in example 1 except that several different concentrations of the Halar™ terpolymer were used as follows:
(weight % of Halar™ terpolymer)
   Example 2 30%
   Example 3 27%
   Example 4 20%
   Example 5 18%
      Physical characteristics of the resultant porous membranes are listed in Table. 1.

### EXAMPLES 6 TO 7

A porous membrane of a Halar™ terpolymer is obtained in the same way as in example 1 except that several different quench temperature can be used as follows:
(quench temperature)
Example 6 40° C.
Example 7 80° C.

### EXAMPLE 8

24% by weight of Halar™ terpolymer (XPM-2TM, produced by Solvay Solexis) and 76% by weight of a tri iso octyl trimellitate (produced by Exxon Mobil Chemical) are mixed in a reactor and heated to 230° C. The extrusion and post treatment are performed as in Example 1. The physical characteristics of the resultant membranes are listed in Table. 1.

### EXAMPLE 9

The porous membranes obtained in Example 1 is annealed at 100° C. for 10 minutes. The physical characteristics of the resultant membrane are listed in Table 1.

TABLE 1

| | Fibre | | | | |
|---|---|---|---|---|---|
| | outer | Wall | | | |
| | diameter | thickness | Pore size | Bubble Pt. | Permeability |
| | (mm) | (mm) | (μm) | (psi) | (gfd/psi) |
| Example 1 | 1.97 | 0.185 | 0.06 | 30.0 | 50.2 |
| Example 2 | 1.97 | 0.185 | 0.03 | 50.4 | 3.2 |
| Example 3 | 1.95 | 0.175 | 0.04 | 40.2 | 8.3 |
| Example 4 | 1.96 | 0.18 | 0.1 | 5.0 | 207.4 |
| Example 5 | 1.96 | 0.18 | 0.19 | 2.3 | 304.5 |
| Example 6 | 1.97 | 0.185 | 0.06 | 28.0 | 49.8 |
| Example 7 | 1.97 | 0.185 | 0.07 | 27.6 | 48.0 |
| Example 8 | 1.97 | 0.185 | 0.02 | 70.0 | 1.0 |
| Example 9 | 1.97 | 0.185 | 0.05 | 32.0 | 48.5 |

The polymer membranes provided by the present invention are useful for membrane-based liquid separation processes, such as microfiltration, ultrafiltration, dialysis, membrane distillation, membrane solvent extraction, membrane gas absorption, stripping, and water treatment and purification.

1. A method of synthesizing a polymeric membrane, the method comprising:
heating and mixing a polymer and a solvent to form a blend;
coating a braided tube with the blend; and
cooling the blend and extracting the solvent to thereby form a polymeric membrane that remains affixed to the braided tube for support.

2. The method of claim 1, wherein the polymer includes at least one of a polyvinylidene compound and an ethylene compound.

3. The method of claim 2, wherein the solvent is a high boiling latent solvent characterized by having a boiling point of about 250° C. or greater, and having a temperature at which the polymer and solvent may be substantially homogenized of about 100° C. or greater.

4. The method of claim 3, wherein the high boiling latent solvent includes at least one of butyl benzyl phthalate, dibutyl phthalate, triacetin, glyceryl diacetin, triisononyl trimellitate, tri isodecyl trimellitate, tri-n-hexyl trimellitate and butyl phthalyl butyl glycolate.

5. The method of claim 4, further comprising adding a nucleating agent in the heating and mixing step.

6. The method of claim 5 wherein, the nucleating agent includes at least one of talc, silica, calcium carbonate and alumina.

7. A method of synthesizing a polymer membrane, the method comprising:
blending a polymer with a high boiling latent solvent characterized by having a boiling point of about 250° C. or greater, and having a temperature at which the polymer melts therein of about 100° C. or greater;
melting the resultant blend;
coating inside of a porous tube with the blend; and
cooling the blend to thereby induce formation of a polymer membrane that remains affixed to the inside of a porous tube for support.

8. The method of claim 7, wherein the tube is made from helically wrapped and overlaying layer of unwoven fabric.

9. The method of claim 7, wherein the polymer includes at least one of a polyvinylidene compound and an ethylene compound.

10. The method of claim 9, wherein the high boiling latent solvent includes at least one of butyl benzyl phthalate, dibutyl phthalate, triacetin, glyceryl diacetin, triisononyl trimellitate, tri isodecyl trimellitate, tri-n-hexyl trimellitate and butyl phthalyl butyl glycolate.

11. The method of claim 10, further comprising adding a nucleating agent.

12. The method of claim 11, wherein the nucleating agent includes at least one of talc, silica, calcium carbonate and alumina.

13. The method of claim 2, wherein the ethylene compound includes at least one of an ethylene chlorotrifluoroethylene copolymer and an ethylene chlorotrifluoroethylene buthyl acrylate terpolymer.

14. The method of claim 3 wherein the polymer comprises an ethylene chlorotrifluoroethylene buthyl acrylate terpolymer.

15. The method of claim 14 wherein the solvent comprises one of triisononyl trimellitate, tri isodecyl trimellitate, tri-n-hexyl trimellitate.

16. A method of synthesizing a polymeric membrane, the method comprising:
heating and mixing an ethylene chlorotrifluoroethylene buthyl acrylate terpolymer and a solvent to form a blend;
shaping the blend; and
cooling the blend and extracting the solvent to thereby form a polymeric membrane.

17. The method of claim 16, wherein the solvent is a high boiling latent solvent characterized by having a boiling point of about 250° C. or greater, and having a temperature at which the poly ethylene chlorotrifluoroethylene buthyl acrylate terpolymer and solvent may be substantially homogenized of about 100° C. or greater.

18. The method of claim 17, wherein the high boiling latent solvent includes at least one of butyl benzyl phthalate, dibutyl phthalate, triacetin, glyceryl diacetin, triisononyl trimellitate, tri isodecyl trimellitate, tri-n-hexyl trimellitate and butyl phthalyl butyl glycolate.

19. The method of claim 18, further comprising adding a nucleating agent in the heating and mixing step.

20. The method of claim 19 wherein, the nucleating agent includes at least one of talc, silica, calcium carbonate and alumina.

21. The method of claim 18 wherein the solvent comprises triisononyl trimellitate.

22. The method of claim 16 wherein the step of shaping comprises spinning the blend onto the outer surface of a hollow tubular braid.
